(19) United States
(12) Patent Application Publication
(10) Pub. No.: US 2010/0232054 A1
(43) Pub. Date: Sep. 16, 2010

(54) MAGNETIC RECORDING MEDIUM AND MAGNETIC STORAGE

(75) Inventors: Katsumi MABUCHI, Hitachi (JP); Kyoko HONBO, Hitachinaka (JP); Nobuhiro KUBO, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi, Ltd.

(21) Appl. No.: 12/709,193

(22) Filed: Feb. 19, 2010

(30) Foreign Application Priority Data
Mar. 16, 2009 (JP) 2009-062720

(51) Int. Cl. G11B 21/02; G11B 5/00; G11B 5/72; G11B 5/667

(52) U.S. Cl. 360/75; 428/836; 428/831; 428/834; 428/828; G9B/5; G9B/21.003; G9B/5.241; G9B/5.28

(57) ABSTRACT

An object of the invention is to provide a magnetic recording medium which exhibits an excellent corrosion resistance. To this end, proposed is a magnetic recording medium including a magnetic recording layer in which: a magnetic body and a filling body alternately appear along a recording surface; and a layer made of a passivated metal or an alloy containing at least one passivated metal is formed in an interface portion between an area of the magnetic body and an area of the filling body.

### BACKGROUND OF THE INVENTION

1. Field of the Invention

The present invention relates to a magnetic recording medium capable of recording a large amount of information, and particularly to a magnetic recording medium suitable for high-density recording. In addition, the present invention relates to a magnetic storage using the magnetic recording medium.

2. Background Art

In recent years, a growing number of small-sized large-capacity magnetic disc apparatuses have been installed in not only personal computers but also household electronic appliances. Against this background, strong demands have been placed on enlargement of capacities of magnetic storages, and on further increase in recording densities of magnetic storages. To satisfy such demands, diligent research and development have been made on magnetic heads and magnetic recording media. Many years have been spent in enlargement of surface recording densities, but far stronger demands have been put on the downsizing of magnetic recording media, and on drastic increase in recording densities of magnetic recording media. To address these demands, proposals have been made on a discrete track medium (see Patent Document 1 (FIG. 1), for instance), and a patterned medium (see Patent Document 2 (paragraph number 0025), for instance). In the discrete track medium, each two adjacent recording tracks are separated from each other by a groove or a non-magnetic body, and are accordingly inhibited from magnetically interfering with each other. In the patterned medium, each two adjacent recording bits are separated from each other by a groove or a non-magnetic body, and are accordingly inhibited from magnetically interfering with each other.

For magnetic recording media, importance is placed on the surface flatness for making sure that a magnetic head is stably floated above the surfaces. For the discrete track media and patterned media, the surface flatness is particularly important because their surface recording densities are higher and their recording magnetic domains are smaller. For this reason, a non-magnetic body is filled in a groove between each two adjacent magnetic areas. Furthermore, a general practice for discrete track media and patterned media is that a protection film made of a carbon-based material is formed on the magnetic recording layers for the purpose of protecting the magnetic recording layers and helping the magnetic recording layers to adsorb the lubricant as in the case of conventional recording media. Out of carbon-based materials, diamond-like carbon (hereinafter referred to as “DLC”) is excellent in surface flatness, durability and corrosion resistance, because DLC is amorphous. For this reason, DLC is used as the material for protection films of the magnetic recording layers (see Patent Document 3 (paragraph number 0025), for instance).

On the other hand, demand for enhanced reliability of the discrete track media and the patterned media has drawn significant attention to corrosion problems. One type of corrosion results from damage which is caused on the media when magnetic films of the media are processed by dry etching and the like so as to have depressions and protrusions. Another type of corrosion results from microscopic gaps or defects between magnetic areas and non-magnetic areas, which are arranged alternately along the recording surfaces of the media. The followings are examples of conventional technologies for enhancing corrosion resistance of the media. As for a vertical-type magnetic recording medium, a soft magnetic underlayer leads to the most serious problem if corrosion occurs, and therefore it has been proposed to enhance the corrosion resistance of the soft magnetic underlayer by selecting an adequate combination of materials and structure of a seed layer formed on the soft magnetic underlayer (see Patent Document 4 (FIG. 1), for instance). As for the discrete track media and the patterned media, it has been proposed to form a conductive film between the magnetic recording layer and the protection film in order to inhibit corrosion in the magnetic areas (see Patent Document 5 (paragraph number 0051), for instance).

Patent Document 1: Japanese Patent Application Publication No. Hei 7-85406

### Patent Document 2: Japanese Patent No. 3286291

### Patent Document 3: Japanese Patent Application Publication No. 2006-120222

### Patent Document 4: Japanese Patent Application Publication No. 2007-184019

### Patent Document 5: Japanese Patent Application Publication No. 2006-228282

### Non-patent Document 1: Atlas of Electrochemical Equilibria in Aqueous Solutions, Maecel Pourbaix, NACE International Cebelcor

### SUMMARY OF INVENTION

The conventional technologies, which are proposed for enhancing the corrosion resistance of the media, employ a layer structure in which: corrosion-inhibiting protection films are formed on the surfaces of the magnetic areas constituting the magnetic recording layer; thereafter, non-magnetic materials are deposited between the protection films; and subsequently, the surfaces of the non-magnetic materials and the protection films are covered with another protection film. In other words, the conventional technologies employ the layer structure in which the two protection films are formed on the surface of each magnetic area. However, this layer structure is problematic because the magnetic recording quality of the medium is deteriorated due to an increase in a magnetic distance between the magnetic head and the magnetic recording medium.

For the purpose of solving this problem, it is demanded to make the overlaid protection film thinner. Nevertheless, as the protection film becomes thinner, it is increasingly more difficult to obtain satisfactory product performance from a viewpoint of the corrosion resistance. To put it specifically, the conventionally-known anti-corrosion technologies for the magnetic recording layer (the magnetic areas) are incapable of satisfying both a higher magnetic recording quality and a higher corrosion resistance in the product at the same time.

With this problem taken into consideration, an object of an aspect of the present invention is to provide a magnetic recording medium: in which a corrosion-resistant layer is formed only between each area of a magnetic body and its neighboring area of a non-magnetic body which constitute a magnetic recording layer; and which is accordingly excellent in magnetic recording quality and corrosion resistance.

An object of another aspect of the present invention is to provide a magnetic storage that fully employs the performance of this magnetic recording medium which is excellent in magnetic recording quality and corrosion resistance.

The present invention can realize the magnetic recording medium which is excellent in corrosion resistance by forming the corrosion-resistant layer only in the interface between each area of the magnetic body and its neighboring area of the non-magnetic body which constitute the magnetic recording layer. Furthermore, when no layer of a material for the magnetic bodies exists under the non-magnetic bodies, the present invention forms the corrosion-resistant layer in an interface between the bottom portion of each non-magnetic body and an underlayer situated under the non-magnetic bodies in addition to the interface between each area of the magnetic body and its neighboring area of the non-magnetic body. Thereby, the present invention can realize the magnetic recording medium which is excellent in corrosion resistance.

In addition, the present invention allows the magnetic recording medium to employ a structure in which the surfaces of the magnetic bodies and the non-magnetic bodies are all covered with a single protection film directly. That is because the corrosion-resistant layer is formed only in the interface between each area of the magnetic body and its neighboring area of the filled body. In short, the present invention can make the protection film thinner. Consequently, the present invention can achieve a higher magnetic recording quality.

### BRIEF DESCRIPTION OF DRAWINGS

FIG. 1 is a diagram schematically showing an example of a cross-sectional structure of a magnetic recording medium according to an embodiment example.

FIGS. 2A-2J are a process drawing showing an instance of a method of manufacturing a magnetic recording medium according to the embodiment example.

FIGS. 3K and 3L are a diagram schematically showing another instance of the cross-section structure of the magnetic recording medium according to the embodiment example.

FIG. 4 is a diagram used to explain correlations between a film thickness of a layer made of a passivated metal (CrTi) and corrosion resistance described in the embodiment example.

FIG. 5 is a schematic plan view used to explain the instance of the magnetic recording storage to the embodiment example.

FIG. 6 is a partial cross-sectional view used to explain the instance of the magnetic storage according to the embodiment example.

FIGS. 7M and 7N are a diagram schematically showing an instance of a cross-sectional structure of a magnetic recording medium according to a comparative example.

### DESCRIPTION OF SYMBOLS

1 magnetic recording medium
11 substrate
12 adhesion layer
13 soft magnetic underlayer
14 seed layer
15 intermediate layer
16 magnetic recording layer
17 magnetic area
18 non-magnetic area
19 layer made of a metal exhibiting a passivated state or its alloy
20 protection film
21 resist
22 stamper
23 lubricant layer
24 protection film
30 patterned medium
31 magnetic head
32 recording/playback signal processing unit
33 driving unit
34 driving unit

### DETAILED DESCRIPTION OF THE PREFERRED EMBODIMENTS

Descriptions will be hereinbelow provided for an embodiment example of the magnetic recording medium and the magnetic storage according to the invention.

### (1) Consideration on Magnetic Recording Medium

The most serious problem with the corrosion of the magnetic recording layer in the magnetic recording medium results from a Co-based alloy which is used in the magnetic areas. The Co-based alloy is not only poor in corrosion resistance, but also has a very undesirable electric potential in an aqueous solution environment. For this reason, the Co-based alloy causes galvanic corrosion (corrosion between dissimilar metals) between the Co-based ally and any neighboring dissimilar metal. In a case of a granular-type magnetic recording layer, for instance, the Co-based alloy segregates oxide into a grain boundary in the magnetic recording layer in an accelerated manner, and accordingly forms Ru or an Ru alloy under the magnetic recording layer. Here, Ru and the Ru alloy are noble metals, and have a high electric potential. For this reason, when a contact portion between Ru or the Ru alloy layer and the magnetic recording layer appears in depression portions which are processed portion of the magnetic recording layer due to process-induced damage or the like, corrosion of the Co-based alloy in the magnetic recording layer starts galvanic corrosion between the Co-based alloy and any Ru or the Ru alloy layer, and accelerates the galvanic corrosion faster than the corrosion of the Co-based alloy alone. In addition, the discrete track media and the patterned media are damaged when their magnetic films are processed by dry etching and the like so as to have depressions and protrusions. For this reason, the discrete track media and the patterned media has an obvious problem that the corrosion is accelerated in the interfaces of the magnetic areas.

On the basis of the consideration on these problems, the inventors propose that, for the purpose of inhibiting corrosion of the magnetic areas in the magnetic recording layer which are situated in the respective processed portions, a layer made of a passivated metal is provided in the magnetic areas in the magnetic recording layer which are situated in the respective processed portions. It was actually proved that, when the layer made of the passivated metal was provided in the magnetic areas in the magnetic recording layer, it was possible to prevent the magnetic recording layer from corroding due to the contact between the dissimilar metals, and due to damage which was caused in the magnetic recording layer when the magnetic recording layer was processed. In the case where the layer made of the passivated metal is provided in the magnetic areas, importance is placed on: what metal should be selected as the material for the passivated metal or its alloy; and what structure should be selected for the layer made of the passivated metal or its alloy.

With the corrosion taken into consideration, the metal layer provided in the magnetic areas in the magnetic recording layer, which are situated in the respective process portions, are required to satisfy the following conditions listed in points (a) to (e).

(a) The metal layer should be made of: a metal or its alloy: which is easily passivated in an aqueous solution; whose oxide is stable; and whose oxide is highly resistant against corrosion in the aqueous solution.

(b) The electric potential of the metal layer should be situated between the electric potential of the intermediate layer and the electric potential of the magnetic recording layer.

(c) The metal layer should be made of a film which has as few defects as possible, and which is smooth and solid.

(d) Once the metal layer becomes defective, the metal layer should be recoverable.

(e) The metal layer should have a structure which does not increase the magnetic distance between the magnetic head and the magnetic recording medium, which accordingly does not deteriorate the magnetic recording quality.

The following point should be noted. The corrosive environment is basically a moisture-containing environment. However, the environment is likely to be alkalized or oxidized due to decomposition of a lubricant, or likely to be contaminated with a chloride. In this context, the metal layer is required to be resistant against corrosion in the environment over a wide pH range.

First of all, the metal layer is examined with regard to the condition listed in point (a). The easiness of the each metal to be passivated and the stability of each produced oxide can be roughly estimated on the basis of the Pourbaix diagram (Non-patent Document 1).

For instance, Ni oxide is stable in a pH range from neutral to alkaline. For this reason, it may be conceived that Ni has higher corrosion resistance in this range than in the other range. Meanwhile, Ni²⁺ ions are stable in the acidic range, and Ni forms no stable Ni oxide or Ni hydroxide in the acidic range. For this reason, one may consider that the corrosion resistance of Ni is deteriorated in the acidic range.

On the other hand, Cr forms stable Cr oxide or hydroxide in a wide pH range from weakly acidic to alkaline. For this reason, it may be presumed that Cr is good in corrosion resistance. Among metals other than Cr, Ta similarly has a passivation property over a wide pH range. For this reason, one may presume that like Cr, Ta has higher corrosion resistance in the wide pH range. W and Mo are passivated in a narrower pH range than the above-mentioned metals are passivated. However, W and Mo form their stable oxides in a pH range from acidic to neutral. For this reason, any one of W and Mo can be expected to have high corrosion resistance. Ti forms a stable Ti oxide in a wide pH range as well, and causes no pitting corrosion (localized corrosion) in a chloride aqueous solution at normal temperature. It may be conceived that Ti is good in corrosion resistance. That is because Ti ions are immediately hydrolyzed with no chloro-complex formation so that TiO₂ is produced. It may be presumed that their alloys exhibit the same properties as their respective pure metals. Use of several corrosion-resistant metals in combination can make the metals exhibit high corrosion resistance. For instance, any alloy obtained by adding at least one of Cr, Mo, W, Pt, Ta and V to Ni can have higher corrosion resistance. These metals satisfy the condition listed in point (a).

Next, the metal layer is examined with regard to the condition listed in point (b). The inventors found that in the atmosphere (or the aqueous solution environment) to which the medium was exposed, the electric potentials of Ru and a Ru alloy were higher than those of Ni and a Ni alloy, which were higher than those of Cr and a Cr alloy, which were higher than those of Co and a Co alloy. Furthermore, the inventors found that the electric potential of Ni was higher than that of Cr in an aqueous solution into which a chloride was mixed. The other passivated metals exhibited a behavior similar to that of Cr. For this reason, the passivated metals and their alloys satisfy the condition listed in point (b).

Next, the metal layer is examined with regard to the condition listed in point (c). Cr has a property in which, when Cr is crystallized, depressions and protrusion in the surface of Cr become larger. For this reason, one may consider that the corrosion resistance of Cr is deteriorated when Cr is crystallized. Nevertheless, an effect of the condition listed in point (d) prevents the corrosion resistance of Cr from being deteriorated to a large extent. A method of preventing Cr from being crystallized is the mixing of Cr with one or more metals so as to form an alloy. The inventors found, for instance, that: an alloy which was made of Cr and Ti, when the percentage of Ti in the alloy is roughly 50%, is amorphous; and the surface of the alloy was smooth. When an alloy is made by adding at least one of V, Cr, Ta and the like to Ni, the Ni-based alloy is excellent in the smoothness of the surface, and the surface of the Ni-based alloy is even.

Next, the metal layer is examined with regard to point (d). Any of the above-mentioned passivated metals forms its oxide through the hydrolyzing of the metal which is once dissolved in an aqueous solution. From this, the inventors found that, even in a case where defects occurred in the metal layer, even in an extreme case where no metal existed in some portions of the metal layer, the defective portions of the metal layer were able to be recovered by redepositing the metal on the defective portions. With these taken into consideration, in the case of discrete track media and patterned media, it is possible to enhance the corrosion resistance of the magnetic recording layer by forming the layer of a passivated metal, which typifies Cr or an amorphous alloy containing Cr, in the interface between each magnetic area and its neighboring filling body area in the magnetic recording layer.

Next, the metal layer is examined with regard to point (e). The inventors found that the condition listed in point (e) was able to be satisfied by removing the passivated metal from the top surface of the magnetic recording layer (a portion of the magnetic recording layer from which the magnetic head reads information, and to which the magnetic head writes information) during the process of manufacturing the magnetic recording medium.

### (2) Embodiment Example

### (2-1) Cross-sectional Structure of Magnetic Recording Medium

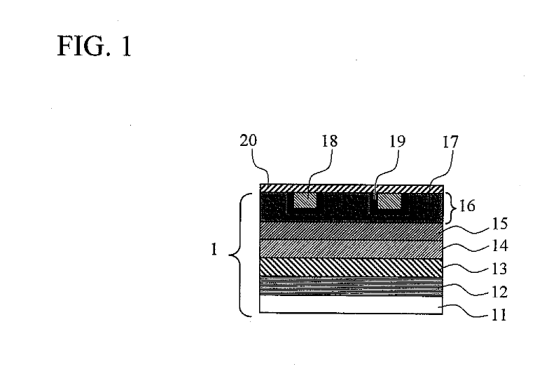

FIG. 1 shows a part of a basic cross-sectional structure which is preferably adopted for a magnetic disc (magnetic recording medium 1) as a patterned medium. A glass disc substrate is used for a substrate 11, for instance. An adhesion layer 12, a soft magnetic underlayer 13, a seed layer 14, an intermediate layer 15 and a magnetic recording layer 16 are sequentially formed on the surface of the substrate 11.

The magnetic recording layer 16 includes: a magnetic body (magnetic material) whose surface is processed so as to be shaped in an alternate series of depression patterns and protrusion patterns; and non-magnetic bodies (non-magnetic materials) which are filled in the respective depression pattern portions. Note that: the protrusion pattern portions are used as magnetic areas 17; and the non-magnetic bodies, which are filled in the depression pattern portions, are used as non-magnetic areas 18. A layer 19 made of a metal exhibiting a passivation performance or an alloy of the metal is formed in only the interface between each magnetic area 17 and its neighboring non-magnetic area 18. In other words, the magnetic recording medium employs a structure in which the layer 19 made of the metal exhibiting the passivation performance or the alloy of the metal does not exist in the top surface of each magnetic area 17.

A protection film 20 having the same film thickness is formed on any portion of the surface of the magnetic recording layer 16, whether the portion may be situated in the surface portion of any magnetic area 17 or in the surface of any non-magnetic area 18. The film thickness includes the manufacturing tolerance. Not that a lubricant is omitted from FIG. 1 although the lubricant is actually applied to the surface of the protection film 20.

No specific restriction is imposed on the material for the adhesion layer 12 as long as the material exhibits an excellent adhesiveness to the substrate and an excellent surface flatness quality. It is desirable that the adhesion layer 12 should be made of an alloy containing at least two metals which are selected from Ni, Al, Ti, Ta, Cr, Zr, Co, Hf, Si and B. To put it more specifically, NiTa, AlTi, AlTa, CrTi, CoTi, NiTaZr, NiCrZr, CrTiAl, CrTiTa, CoTiNi, CoTiAl and the like may be used as the material for the adhesion layer 12.

No specific restriction is imposed on the material for the soft magnetic underlayer 13, as long as the material enables the soft magnetic underlayer 13 to exhibit: a saturation magnetic flux density (BS) which is at least 1 tesla or more than 1 tesla; a uniaxial anisotropy in the radial direction of the disc substrate; a coercive force which measures 1.6 kA/m or less in the head-running direction; and an excellent surface flatness quality. The soft magnetic underlayer 13 can obtain the necessary properties, for instance, when the soft magnetic underlayer 13 is made of an amorphous alloy obtained by adding Ta, Hf, Nb, Zr, Si, B, C or the like to Co, Ni or Fe as the main component. Furthermore, when the soft magnetic underlayer 13 is formed with a laminated structure, which includes the soft magnetic underlayer 13 and a non-magnet layer inserted under the soft magnetic underlayer 13, it is possible to reduce the noise. It is desirable that, for instance, a CoCr alloy, Ru, Cr, Cu, MgO or the like should be used as the material for this non-magnetic layer.

The role expected to be played by the seed layer 14 is to control the orientation and grain size of the intermediate layer 15. For this reason, an fcc (face-centered cubic) alloy essentially containing Ni may be used for the seed layer 14. A typical instance of the fcc alloy used for the seed layer 14 is an alloy which contains Ni and at least one selected from W, Fe, Ta, Ti, Ta, Nb, Cr, Mo, V, Cu and the like. In addition, the seed layer 14 may be formed with a double-layered structure for the purpose of enhancing the corrosion resistance. The double-layered structure may be constructed by including: a seed layer (second seed layer) placed closer to the magnetic recording layer; and a seed layer (first seed layer) inserted between the second seed layer and the soft magnetic underlayer 13. In this respect, the seed layer 14 made of the above-mentioned alloy is used as the second seed layer; and the first seed layer is made of an alloy obtained by adding Ta, Ti, Nb or Al to Cr.

An alloy solely or essentially containing Ru with an hcp (hexagonal closest packing) lattice structure or fcc structure may be used as the intermediate layer 15.

An alloy with a granular structure is used as the magnetic material for the magnetic areas 17 in the magnetic recording layer 16. Instances of the main component of the alloy include: a CoCr-based alloy such as a CoCrPt alloy; and a FePt-based alloy. The alloy with the granular structure is obtained by adding an oxide such as SiO₂ to the main component. To put is specifically, CoCrPt—SiO₂, CoCrPt—MgO, CoCrPt—TaO or the like is used as the material for the magnetic areas 17. On the other hand, an oxide, nitride or carbide is used as the material for the non-magnetic areas 18 in the magnetic recording layer 16. Instances of the oxide include SiO₂, Al₂O₃, TiO₂ and ferrites. An instance of the carbide is AlN. An instance of the carbide is SiC. For reference, it is desirable that: the concentration of Co should be to 25 at %; and the concentration of Cr should be 10 to 20 at %. The layers 19 each made of the passivated metal or its alloy are formed in the interfaces between the magnetic areas 17 and the non-magnetic areas 18 in the magnetic recording layer, respectively. The metal used for the layers 19 is Cr, Ti, Ni, Mo, Nb, W, Ta, Zr, or an alloy containing at least one of Cr, Ti, Ni, Mo, Nb, W, Ta and Zr. It is desirable that particularly an alloy containing Cr should be used. FIG. 1 illustrates that the layers 19 each made of the passivated metal or its alloy are formed in the entire interfaces between the magnetic areas 17 and the non-magnetic areas 18 with a constant film thickness. In reality, however, the film thickness of each layer 19 is likely to vary in the vertical portions of each corresponding interface (in other words, the sidewalls of each corresponding depression portion) which are formed extending in a direction perpendicular to the recording surface.

Ideally, it goes without saying it is desirable that the entire sidewalls of each interface should be covered with each corresponding layer 19 made of the passivated metal or its alloy which has a film thickness thicker than a predetermined thickness. Nevertheless, it is conceivable that: the film thickness of each layer 19 made of the passivated metal or its alloy is partially thinner in each corresponding interface; and/or each layer 19 is not formed in some portion of each corresponding interface. Even in the case of the partial thinness and the partial failure in the layer formation, the layers 19 can fulfill their basic effect, namely the simultaneous satisfaction of the magnetic recording quality and corrosion resistance, as long as the layers 19 are securely formed with a film thickness thicker than the predetermined thickness, and with a coverage ratio higher than a predetermined value.

A hard carbon film, whose typical instance is a film made of diamond-like carbon or the like, is used as the material for the protection film 20 formed on the magnetic recording layer 16. In addition, a lubricant layer is formed on the protection film 20, although not illustrated in FIG. 1. Any of Fomblin or PFPE (perfluoropolyether)-based lubricants may be used for the lubricant layer.

### (2-2) Manufacturing Method

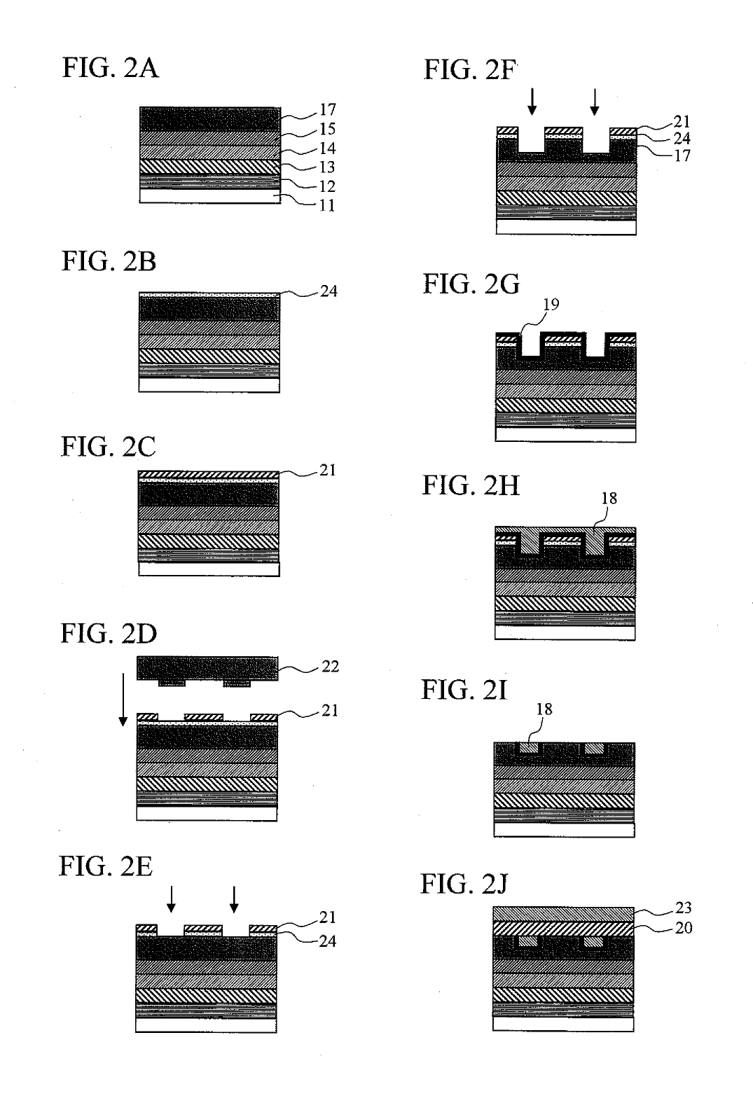

Descriptions will be hereinbelow provided for an instance of a method of manufacturing the magnetic recording medium 1 according to this embodiment example on the basis of FIG. 2. Basically, the magnetic recording medium 1 is manufactured by use of Sputter Equipment (C3010) made by Canon Anelva Corporation. This sputtering machine includes 10 process chambers and one substrate introduction chamber. This sputter machine is designed so that air is discharged from each chamber independently. The air discharge capability of each chamber brings the chamber's internal pressure to as low as 6×10⁻⁶ Pa. In the case of this embodiment example, a glass substrate with a diameter of 63.5 mm is used as the substrate 11.

First of all, as shown in FIG. 2A, the adhesion layer 12, the soft magnetic underlayer 13, the seed layer 14, the intermediate layer 15 and a magnetic material layer (a base material for the magnetic areas 17) are sequentially formed by sputtering. A typical composition and film thickness of each of these layers are as follows. The compositions and film thicknesses shown in Table 1 are typical instances. Even if the layers are respectively formed with compositions and film thicknesses which are different from those shown in Table 1, the same result can be obtained from the layers as thus formed. For instance, the seed layer 14, as formed so that Cr₅₀Ti₅₀ is used for the first seed layer while Ni₉₀Ti₁₀ is used for the second seed layer, can obtain a result similar to that of the seed layer 14 as formed so that the compositions shown in Table 1 are used for the first and second seed layer. In addition, the seed layer 14, as formed as a single-layered layer made of NiWTa instead of as a double-layered layer having the two seed layers, can also obtain a result similar to that of the seed layer 14 as formed so that the compositions shown in Table 1 are used for the first and second seed layer. Furthermore, the magnetic recording layer 16, as made of CoCrPt—TaO, can obtain a result similar to that of the magnetic recording layer 16 as made of the composition shown in Table 1.

TABLE 1

| | | target | |
|---|---|---|---|
| | | composition | film thickness |
| | | (at %) | (nm) |
| adhesion layer | | Ni₆₃Ta₃₇ | 10 |
| soft magnetic | first soft | Co₉₂Ta₃Zr₅ | 50 |
| underlayer | magnetic layer | | |
| | non-magnetic | Ru | 0.8 |
| | layer | | |
| | second soft | Co₉₂Ta₃Zr₅ | 50 |
| | magnetic layer | | |
| seed layer | first seed layer | Ta₇₀Cr₃₀ | 2 |
| | second seed layer | Ni₉₂W₈ | 5 |

| | | |
|---|---|---|
| intermediate layer | Ru | 16 |
| magnetic recording layer | CoCrPt—SiO₂ | 16 (largest |
| | | portion) |

Subsequently, as shown in FIG. 2B, a protection film 24 is formed on the magnetic material layer (the base material for the magnetic areas 17). After that, as shown in FIG. 2C, a resist 21 is applied to the top of the protection film 24 by spin coating. For instance, any of positive-type resists is used as the material for the resist 21. Note that this protection film 24 is used for the purpose of protecting the magnetic material layer (the base material for the magnetic areas 17) from corrosion in a step of forming a discrete track by use of the applied resist 21.

Afterward, as shown in FIG. 2D, the depression patterns and protrusion patterns, which alternate with one another at predetermined intervals corresponding to servo patterns in a servo area and track patterns in a data area, are transferred to this resist 21 by nanoimprint lithography using a transfer apparatus.

Subsequently, as shown in FIG. 2E, portions of the protection film 24, which are exposed to the outside through the removed portions (opening portions) of the resist 21, are removed from the protection film 24 by reactive ion beam etching.

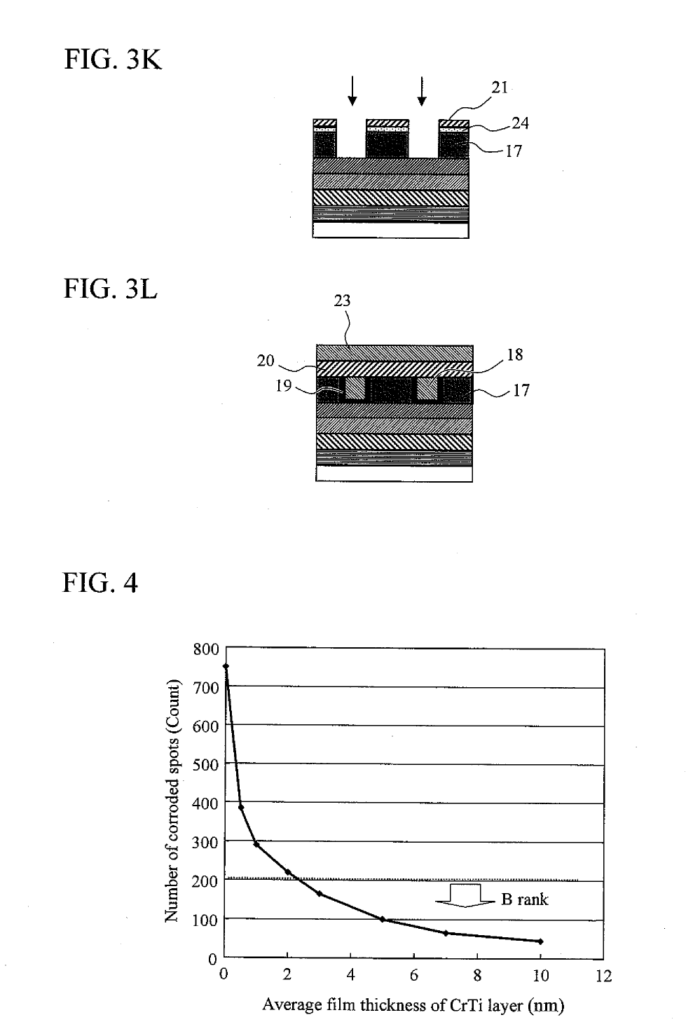

Thereafter, as shown in FIG. 2F, portions of the magnetic material layer (the base material for the magnetic areas 17) are removed from the magnetic material layer by ion milling. Thereby, the depression pattern portions are formed. In other words, the depression patterns and the protrusion patterns are formed in the surface of the magnetic material layer (the base material for the magnetic areas 17). As shown in FIG. 3K, it does not matter whether or not the portions removed from the magnetic material layer reach the intermediate layer 15 which serves as a foundation for the magnetic recording layer 16. The areas formed by removing the portions from the magnetic material layer are not used for the recoding. From a viewpoint of prevention of magnetic interference, it is desirable that no portion of the magnetic material should exist in each such area.

Afterward, as shown in FIG. 2G, the layer 19 made of the passivated metal or its alloy is formed on all the exposed surfaces by sputtering. In other words, the layer 19 made of the passivated metal or its alloy is deposited on the side and bottom surfaces of each depression portion. Note that, when portions of the intermediate layer 15 are exposed to the outside as shown in FIG. 3K, the layer 19 made of the passivated metal or its alloy is deposited on the exposed surfaces.

After that, as shown in FIG. 2H, by sputtering, a non-magnetic material layer (a base material for the non-magnetic areas 18 is filled in or on the surface of the processed body, which has undergone the above-described steps, with a thickness slightly thicker than the thickness (depth) of the depression portions.

Subsequently, as shown in FIG. 2I, by etching (for instance, CMP (chemical mechanical polishing)), the surface of the medium is smoothed with peaks or depressions being removed until the magnetic material layer (the base material for the magnetic areas 17) is exposed to the outside. During this step, all the resist 21, all the protection film 24, the excessive portions of the layer 19 made of the passivated metal or its alloy, and the excessive portions of the non-magnetic layer (each non-magnetic area 18) are removed.

Thereafter, as shown in FIG. 2(J), the protection layer 20 is deposited on the smoothed surface by chemical vapor deposition (CVD). Afterward, a fluid lubricant layer 23 is applied to the protection layer 20. Thereby, the magnetic recording medium with the structure shown in FIG. 1 can be produced. Note that, when the manufacturing process uses the structure shown as 3K (when portions of the intermediate layer 15 are exposed to the outside), the magnetic recording medium having a structure as shown in FIG. 3L is produced.

### (2-3) Evaluation of Corrosion Resistance

The corrosion resistance was evaluated in accordance with the following sequence. First of all, samples of the magnetic recording medium were left as it was in a high-temperature and high-humidity environment at temperature of 60° C. at relative humidity of 90% RH or higher for 96 hours. Thereafter, for each sample, the number of corroded spots was counted in a portion of the surface of the magnetic recording medium which was situated in a range of 14 mm to 25 mm in the radius of the magnetic recording medium by use of an optical surface analyzer. Each sample was rated by use of the following scale. When a sample showed that the counted number of corroded spots was not more than 50, the sample was rated at A. When a sample showed that the counted number of corroded spots was not less than 50 but not more than 200, the sample was rated at B. When a sample showed that the counted number of corroded spots was not less than 200 but not more than 500, the sample was rated at C. When a sample showed that the counted number of corroded spots was not less than 500, the sample was rated at D. Magnetic recording media, which were represented by samples rated at B or higher, are desirable from a viewpoint of the practical use.

### (3) Descriptions Will be Hereinbelow Provided for Concrete Examples by Use of the Tables and Drawings

### (3-1) Example 1

A magnetic recording medium with a layer configuration shown in FIG. 1 and Table 1 was used for this example. A filler used for this magnetic recording medium was SiO₂. Additionally, Cr₅₀Ti₅₀ was used for the layer 19 made of the passivated metal or its alloy which was formed in an interface between each magnetic area 17 and each corresponding non-magnetic area (filled area) 18 (in the case FIG. 1, inclusively on the bottom surface of each corresponding depression portion of the magnetic material layer (the base material for the magnetic areas 17)). In addition, the film thickness was set at approximately 5 nm on the average. In this respect, the average film thickness means a film thickness of a layer which was formed on a flat substrate under the same condition by sputtering. When the corrosion resistance and medium S/N (signal to noise) ratio of this magnetic recording medium (Sample 1-1) were examined, the magnetic recording medium (Sample 1-1) exhibited a high S/N ratio, which was not lower than 18 dB, and an excellent corrosion resistance which was rated at A.

### (3-2) Example 2

After that, magnetic recording media (Samples 2-1 to 2-10) were made by using metals, which were changed from Cr50Ti50, for the layers 19 each made of the passivated metal or its alloy which were respectively formed in the interfaces between the magnetic areas 17 and the non-magnetic areas (filled areas) 18. Subsequently, for each of these magnetic recording media (Samples 2-1 to 2-10), the corrosion resistance and medium S/N ratio were evaluated as in the case of the magnetic recording medium according to Example 1. Table 2 shows a result of the evaluation which was made on the medium S/N ratio and corrosion resistance of each of the magnetic recording media. Note that the average film thickness of each layer 19 was 5 nm in each of the magnetic recording media.

TABLE 2

| | magnetic area/filling | |
|---|---|---|
| | body area | |
| | sputtering metal | |
| sample | composition | corrosion resistance rank |
| 2-1 | Ta₇₀Cr₃₀ | A |
| 2-2 | Cr₇₀Nb₃₀ | A |
| 2-3 | Cr₅₀Zr₅₀ | A |
| 2-4 | Cr₅₀Ti₄₅Nb₅ | A |
| 2-5 | Cr₅₀Ti₄₅l₅ | A |
| 2-6 | Cr₅₀Ti₄₅Si₅ | A |
| 2-7 | Ta₆₅Cr₃₀Al₅ | A |
| 2-8 | Ta₆₅Cr₃₀Si₅ | A |
| 2-9 | Cr | B |
| 2-10 | Ni₅₀Ta₅₀ | B |

All the samples exhibited an excellent corrosion resistance and a satisfactory medium S/N ratio which was 18 dB or higher. These metals were excellent in corrosion resistance. Judging from this, it was apparent that these metals were excellent in the property of adhesiveness to CoCrPt—SiO₂ of which the respective magnetic recording layers used for this comparative experiment were made. Cr of Sample 2-9 and Ni₅₀Ta₅₀ of Sample 2-10 were slightly inferior to the metals of Samples 2-1 to 2-8 in corrosion resistance. The reason for their inferiority can be explained as follows. One may consider that the inferiority of Cr came from the fact that Cr was a crystalline metal and therefore included many crystal defects. On the other hand, it may be conceived that the inferiority of the metal containing Ni came from the fact that Ni in an acid aqueous solution did not form Ni oxide or Ni hydroxide that exhibits protective effect; and the fcc crystal structure made the Ni₅₀Ta₅₀ thin film include many crystal defects.

### (3-3) Example 3

Thereafter, by changing its film thickness, an examination was made on a magnetic recording layer in which Ci₅₀Ti₅₀ was unchangedly used as the composition of the layer 19 made of the passivated metal or its alloy, which was deposited on the surface of the magnetic material layer (the base material for the magnetic areas 17) including the formed depression and protrusion patterns. As shown in FIG. 4, when the average film thickness of the layers 19 was 2 nm or less, the corrosion resistance of the magnetic recording layer was rated at C or lower. It was clear that the thin average film thickness of the layers 19 degraded the corrosion resistance. The reason for this degradation is that when the average film thickness was thin, the vertical portions of the interface between each magnetic area and its neighboring non-magnetic area in the magnetic recording layer were not fully covered with the passivated metal because the passivated material was sputtered in the direction perpendicular to the substrate 11.

For the purpose of covering the entire inner wall surfaces of each depression pattern portion in the magnetic material layer (the base metal for the magnetic areas 17) with the layer 19 made of the passivated metal or its alloy, the passivated metal needs to continue to be sputtered for a sufficient length of time until the average film thickness becomes equal to 10 nm or more.

As described above, however, the passivated metal exerts a passivation capability in defective portions and non-sputtered areas when the passivated metal is redeposited. For this reason, even when the average film thickness of the passivated metal is 10 nm or less, as the redeposition of the passivated metal with an average film thickness of 2 nm or more can increase its average film thickness, the passivated metal reduces the number of corroded spots to an extent that the magnetic recording medium is rated at B. When the average film thickness is 2 nm or less, even the redeposition of the passivated metal cannot recover all the defective portions, and the amount of corrosion remains large.

### (3-4) Example 4

Subsequently, an examination was made on the magnetic recording medium by changing the composition of the magnetic recording layer 16. Note that the thickest portion of the magnetic recording layer 16 was set at 15 nm in film thickness. The basic structure of the magnetic recording medium was the same as that of the magnetic recording medium according to Sample 1-1, except for the composition of their magnetic recording layer. The magnetic recording layer 16 according to Sample 3-1 had a granular structure in which Ta oxide was added to CoCrPt. The magnetic recording layers 16 according to Sample 3-2 and 3-3 were formed as multi-layered layers obtained by alternately laminating a Co layer and a Pd layer, or by alternately laminating a Co layer and a Pt layer. As shown in Table 3, the corrosion resistance of the respective magnetic recording media were unchangedly rated at A, even though the composition of the magnetic recording layers 16 were different from one another. It was presumed that the adhesiveness of the magnetic recording layer 16 to the passivated metal was satisfactory in each sample.

TABLE 3

| | structure of magnetic | corrosion resistance |
|---|---|---|
| sample | recording layer | rank |
| 3-1 | CoCrPt—TaO | A |
| 3-2 | [Co/Pd]₂₀ | A |
| 3-3 | [Co/Pt]₂₀ | A |

### (3-5) Example 5

For this example, descriptions will be provided for a sample (shown in FIG. 3L; Sample 4-1) obtained by adopting the structure shown in FIG. 3K for the magnetic recording medium in the manufacturing process. Sample 4-1 was able to be made by the following manufacturing step sequence after the structure shown in FIG. 3K was obtained. The obtaining of the structure shown in FIG. 3L was followed by the deposition of the non-magnetic material layer (the base material for the non-magnetic areas 18), which is followed by the removing of the protection film 24 and the resist 21 (by CMP, for instance), which is followed by the forming of the protection film 23, which is followed by the application of the lubricant. Note that the magnetic recording layer 16 according to Sample 4-1 was made by use of the same material and film thickness as was the magnetic recording layer 16 according to Sample 1-1. An examination on the corrosion resistance and medium S/N ratio of Sample 4-1 confirmed that the magnetic recording medium obtained: a high medium S/N ratio which was 18 dB or higher; and an excellent corrosion resistance which was rated at A.

### (4) Example of Magnetic Storage

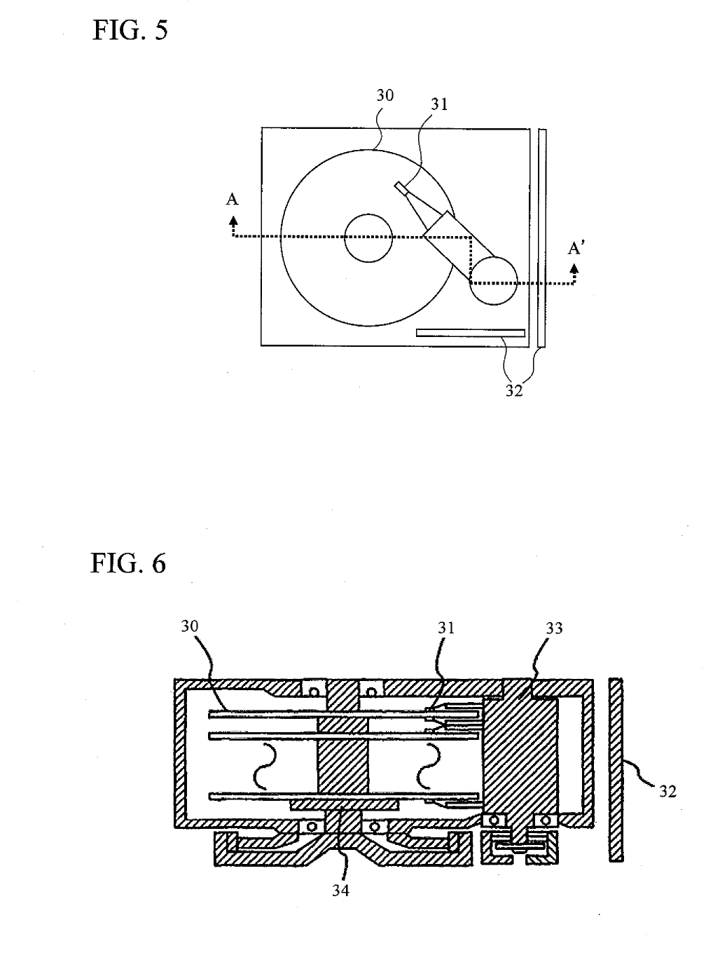

FIG. 5 shows a schematic plan view of a magnetic storage in which any of the various magnetic recording media, which have been explained with the foregoing examples, is installed. In addition, FIG. 6 shows a cross-sectional view of the magnetic storage taken along the A-A′ line of FIG. 5. Note that the magnetic storage has the same configuration as does a publicly-known magnetic storage, except for the configuration of the magnetic recording medium. In its casing, the magnetic storage includes: a patterned medium 30 corresponding to the above-described magnetic recording medium; a driving unit 34 configured to rotationally drive the patterned medium 30; a magnetic head 31 including a recording/playback unit; a driving unit 33 configured to move the magnetic head 31 relative to the patterned medium 30; and a recording/playback signal processing unit 32 configured to input a signal into the magnetic head 31, and to reproduce an output signal from the magnetic head 31.

In the case of this embodiment example, a combined-type head is used as the magnetic head 31. For instance, the magnetic head 31 includes a magnetic head which uses a trailing shield head-type recording head and a shield-type MR (magnetic resonance) playback device (GMR (giant magnetoresistive) film, TMR (tunneling magnetoresistive) film, or the like). The magnetic storage according to this embodiment example includes: the magnetic recording medium which is excellent in corrosion resistance; and the magnetic head whose magnetic gradient is steep. This enables the magnetic storage to achieve an excellent corrosion resistance. To put it specifically, it is possible to realize the magnetic storage having a recording density which is 95 or more gigabits per square centimeter.

### (5) Comparative Example

For reference, descriptions will be provided for some sample examples of a magnetic recording medium which did not use the layer structure of the magnetic recording medium according to the embodiment example.

### (5-1) Comparative Example 1

A magnetic recording layer (Sample 5-1), which included no layer 19 made of the passivated metal or its alloy, exhibited a very poor corrosion resistance as indicated by the number of corroded spots corresponding to a case where the average film thickness of the CrTi layer is 0 nm in FIG. 4.

### (5-2) Comparative Example 2

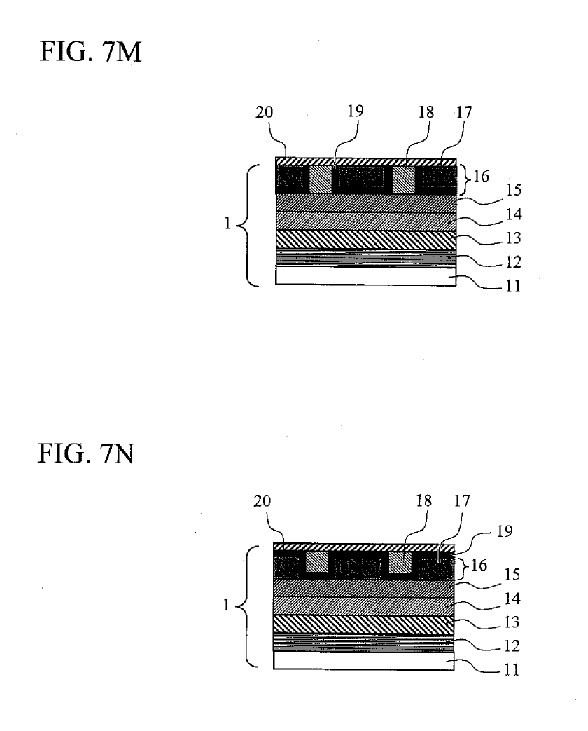

Subsequently, an examination was made on a magnetic recording medium (Sample 6-1) in which, as shown in FIG. 7M (from which the lubricant layer is omitted), a layer made of a passivated metal (CrTi) was formed in the interface (extending in the perpendicular direction) between each magnetic area 17 and each corresponding non-magnetic area 18 in the magnetic recording layer 16, as well as under the bottom portion of each magnetic area 17 (namely, in the interface between each magnetic area 17 and the intermediate layer 15). In accordance with the manufacturing sequence shown in FIG. 2, the magnetic recording medium according to Sample 6-1 was able to be produced by: forming the non-magnetic material layer (the base material for the non-magnetic areas 18) after the intermediate layer 15 was formed; thereafter forming the predetermined depression and protrusion patterns by nanoprinting and etching; afterward forming the layer 19 made of the passivated metal or its alloy; and subsequently forming the magnetic material layer (the base material for the magnetic areas 17).

The magnetic recording layer according to Sample 6-1 exhibited an excellent corrosion resistance which was rated at A, but the medium S/N ratio of it was as low as 13.5 dB. The reason for these evaluation results may be conceived as follows. The corrosion resistance of the magnetic recording layer was enhanced, because the layers 19 each made of the passivated metal or its alloy were provided to the magnetic recording layer. Meanwhile, because the layers each made of the metal exhibiting the passivation state existed on the intermediate layer on which to form the magnetic recording layer, the orientation of the magnetic recording layer was unable to be controlled adequately.

### (5-3) Comparative Example 3

Subsequently, an examination was made on a magnetic recording layer (Sample 7-1) in which, as shown in FIG. 7N (from which the lubricant layer is omitted), the layer 19 made of the passivated metal or its alloy was formed in the interface between each magnetic area 17 and the protection film 20. The corrosion resistance of the magnetic recording layer according to Sample 7-1 was also so excellent as to be rated at A, whereas the medium S/N ratio of Sample 7-1 was as low as 14.3 dB. The excellence of the corrosion resistance resulted from the effect of the layer 19 made of the passivated metal or its alloy. One may infer that the low medium S/N ratio resulted from increase in the magnetic distance between the magnetic head and the magnetic recording layer. This inference is based on the fact that: the layer 19 made of the passivated metal or its alloy was inserted in the interface between each magnetic area 17 and the protection film 20; and the inserted layer 19 made of the passivated metal or its alloy was a non-magnetic material.

### (5-4) Comparative Example 4

Next, descriptions will be provided for the corrosion resistance of magnetic recording layers (Samples 8-1 to 8-5) in each of which, instead of the layer 19 made of the passivated metal or its alloy, a layer made of a different metal (with an average film thickness of 5 nm) was formed in the interface between each magnetic area 17 and each corresponding area 18. Note that the basic composition and film thickness of each of the thus-formed magnetic recording layers were the same as those of the magnetic recording layer according to Example 1, except that the layer made of the different metal was formed instead of the layer 19 made of the passivated metal or its alloy. As shown in Table 4, the magnetic recording layers exhibited unsatisfactory corrosion resistance against any metal or carbon. It is conceivable that the unsatisfactory corrosion resistance of the magnetic recording layers resulted from the properties of the materials of the magnetic recording layers according to Samples 8-1 to 8-5. On one hand, the materials themselves were good at corrosion resistance. On the other hand, however, the materials did not become passivated by elution or redeposition as mentioned above. One may infer that: their unpassivated states hindered the materials from covering the vertical surfaces of any depression pattern portion formed in the magnetic material layer (the base material for the magnetic areas 17); and the magnetic material layer was accordingly exposed to the outside in its uncovered portions. The magnetic recording layers according Sample 8-6 and 8-7 did not exhibit satisfactory corrosion resistance, either. It may be conceived that the reason for their unsatisfactory corrosion resistance resulted from the fact that the materials themselves were not so good at corrosion resistance.

TABLE 4

| | magnetic area/filling | |
|---|---|---|
| | body area | |
| | sputtering metal | corrosion resistance |
| sample | composition | rank |
| 8-1 | Pt | C |
| 8-2 | Au | C |
| 8-3 | Ru | C |
| 8-4 | DLC | C |
| 8-5 | amorphous carbon | C |
| 8-6 | Al | C |
| 8-7 | Cu | C |

### (6) CONCLUSION

As described above, it is apparent that, when the discrete track and the patterned medium are made to enable the magnetic recording medium to simultaneously realize the high medium S/N ratio and the excellent corrosion resistance, it is effective for the layer 19 made of the passivated metal or its alloy to be formed only in the interface between each magnetic area 17 and its neighboring non-magnetic area 18 which constitute the magnetic recording layer as shown in FIG. 1.

In addition, as shown in FIG. 3L, it is clear that, when no magnetic material layer exists under the non-magnetic areas 18, it is effective for the layer 19 made of the passivated metal or its alloy to be formed in the interface between the bottom portion of each non-magnetic area 18 and the intermediate layer 15 situated under the non-magnetic area 18.

What is claimed is:

1. A magnetic recording medium comprising
a magnetic recording layer in which: a magnetic body and a non-magnetic body alternately appear along a recording surface; and a layer made of any one of a passivated metal and an alloy containing at least one passivated metal is formed only in an interface portion between an area of the magnetic body and an area of the non-magnetic body.

2. The magnetic recording medium according to claim 1, wherein
the interface portion is at least a part of the interface between the area of the magnetic body and the area of the non-magnetic body.

3. The magnetic recording medium according to claim 1, further comprising
a layer made of any one of the passivated metal and the alloy containing at least one passivated metal is formed in an interface between a bottom portion of the non-magnetic body and an underlayer situated under the non-magnetic body when no material layer of the magnetic body exists under the non-magnetic body.

4. A magnetic recording medium comprising
a magnetic recording layer in which: a magnetic body and a non-magnetic body alternately appear along a recording surface; and an area of the magnetic body and an area of the non-magnetic body are in contact with each other with a layer interposed therebetween, the layer made of any one of a passivated metal and an alloy containing at least one passivated metal.

5. The magnetic recording medium according to claim 1, wherein
a component of any one of the passivated metal and the alloy containing at least one passivated metal is selected from Cr, Ti, Ta, Zr, Nb, Al, Si and Ni.

6. The magnetic recording medium according to claim 1, further comprising
a structure in which a top surface of the magnetic body and a top surface of the non-magnetic body are directly covered with a single protection film.

7. The magnetic recording medium according to claim 1, wherein
a soft magnetic underlayer, an intermediate layer and the magnetic recording layer are laminated in this order on a substrate.

8. A magnetic storage comprising:
a magnetic recording medium;
a first driving unit configured to drive the magnetic recording medium in a recording direction;
a magnetic head including a recording unit and a playback unit;
a second driving unit configured to drive the magnetic head relative to the magnetic recording medium; and
a signal processing unit configured to process a waveform of an input signal inputted into the magnetic head and a waveform of an output signal outputted from the magnetic head, wherein
the magnetic recording medium includes a magnetic recording layer in which: a magnetic body and a filling body alternately appear along a recording surface; and a layer made of any one of a passivated metal and an alloy containing at least one passivated metal is formed in an interface portion between an area of the magnetic body and an area of the filling body.
